(19) United States
(12) Patent Application Publication
(10) Pub. No.: US 2015/0326419 A1
(43) Pub. Date: Nov. 12, 2015

(54) RADIO SYSTEM FOR SIMULTANEOUS MULTI-CHANNEL RECEPTION

(71) Applicant: TEXAS INSTRUMENTS DEUTSCHLAND GMBH, Freising (DE)

(72) Inventors: Juergen MAYER-ZINTEL, Allershausen (DE); Christian KELLER, Moosinning (DE); Andreas HAGL, Dachau (DE)

(21) Appl. No.: 14/272,154

(22) Filed: May 7, 2014

(51) Int. Cl. H04L 27/26

(52) U.S. Cl. CPC H04L 27/2647; H04L 27/2653; H04L 27/2657

(57) ABSTRACT

A radio communication system includes a frequency synthesizer, a radio frequency (RF) front end, a first receiver, and a second receiver. The frequency synthesizer is configured to generate an oscillation signal, and the RF front end is configured to receive a detected RF signal and apply the oscillation signal to downconvert the RF signal to an intermediate frequency (IF) signal. More particularly, the first receiver, coupled to the RF front end, is configured to extract, from the IF signal, information wirelessly transmitted by a first RF transmitter on a first frequency channel. The second receiver, coupled to the RF front end, is configured to extract, from the IF signal concurrently with the extraction of signal information by the first receiver, information wirelessly transmitted by a second RF transmitter on a second frequency channel.

### CROSS-REFERENCE TO RELATED APPLICATION

None.

### BACKGROUND

Wireless communication systems have found applications in a variety of contexts involving information transfer over long and short distances. Generally, wireless communications involve radio frequency (RF) carrier signal that is variously modulated to represent data, and the modulation, transmission, receipt, and demodulation of the signal.

A transceiver, including a coupled transmitter and a receiver, is a fundamental component of any wireless communication system. Commonly speaking, the transceiver, with a baseband processing system, encodes digital data to a baseband signal, modulates the baseband signal with an RF carrier signal, and transmits the modulated RF signal by the transmitter. Upon receipt of the modulated RF signal by the receiver, the receiver downconverts the RF signal, demodulates the baseband signal, and decodes the digital data represented by the baseband signal.

### SUMMARY

Systems to simultaneously receive multiple frequency channels while using a single synthesizer are disclosed herein. In an embodiment, a radio communication system includes a frequency synthesizer, a radio frequency (RF) front end, a first receiver, and a second receiver. The frequency synthesizer is configured to generate an oscillation signal, and the RF front end is configured to receive a detected RF signal and apply the oscillation signal to downconvert the RF signal to an intermediate frequency (IF) signal. More particularly, the first receiver, coupled to the RF front end, is configured to extract, from the IF signal, information wirelessly transmitted by a first RF transmitter on a first frequency channel. The second receiver, coupled to the RF front end, is configured to extract, from the IF signal concurrently with the extraction of signal information by the first receiver, information wirelessly transmitted by a second RF transmitter on a second frequency channel.

In another embodiment, an apparatus includes a frequency synthesizer configured to generate a signal at a local oscillation (LO) frequency, and a radio frequency (RF) front end, comprising a first pair of mixers and a second pair of mixers, configured to downconvert a received RF signal to an intermediate frequency (IF) signal using the LO frequency. The apparatus further includes a first receiver coupled to the first pair of mixers and a second receiver coupled to the second pair of mixers. The first receiver is configured to process the IF signal at a first frequency channel, and the second receiver is configured to process, concurrently with the processed IF signal by the first receiver, the IF signal at a second frequency channel.

In accordance with a further embodiment, a transceiver includes a common antenna configured to receive and transmit a radio frequency (RF) signal, a single frequency synthesizer configured to generate a signal at an oscillation frequency, a radio frequency (RF) front end coupled to the antenna, a transmitter configured to transmit a RF signal over the common antenna, a first receiver coupled to the RF front end, and a second receiver coupled to the RF front end. More particularly, the RF front end is configured to downconvert the received RF signal to an intermediate frequency (IF) signal based on the generated oscillation frequency. The first receiver is configured to extract, from the IF signal, information wirelessly transmitted by a first RF transmitter on a first frequency channel. The second receiver is configured to extract, from the IF signal, concurrently with the extraction of signal information by the first receiver, information wirelessly transmitted by a second RF transmitter on a second frequency channel.

### BRIEF DESCRIPTION OF THE DRAWINGS

For a detailed description of exemplary embodiments of the invention, reference will now be made to the accompanying drawings in which:

FIG. 1 shows a block diagram of an exemplary radio communication system in accordance with various embodiments;

FIG. 2 shows a graph illustrating signals processed in a radio communication system in accordance with various embodiments;

FIG. 3 shows a block diagram of a zero-intermediate frequency (IF) receiver in accordance with various embodiments; and

FIG. 4 shows a block diagram of a low-IF receiver in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Wireless communication systems, are often used to transfer disparate data types or data streams. Such transfers may be accomplished by time multiplexing the different data types on a shared frequency band or by transferring the different data types on different frequency bands. Unfortunately, time multiplexing may unacceptably delay transmission of critical of data. For example, in an automotive application time multiplexing may delay transfer of critical data, such as tire pressure measurement data. Accordingly, a receiver for automotive wireless use may require an exclusive frequency channel to continuously monitor the air pressure inside the tires of the vehicle or other vehicle's condition information, in addition to the exclusive channel, there may be one or more other channels can be simultaneously used in wireless communications of the vehicle, for example, a remote keyless system (RKS). In another example, for a home automation application, at least two of channels in wireless communications may be simultaneously used. More specifically, a first channel with a higher priority is used to monitor a centralized control of doors in a house, and a second channel with a lower priority used to monitor temperature changes in the house.

To simultaneously receive multiple frequency channels, a conventional receiver may require more than one synthesizer to generate plural local oscillation (LO) frequencies. Although the success of miniaturization and cost reduction of complementary metal-oxide-semiconductor (CMOS) technology has been demonstrated in producing circuitry of the transceiver, integrating any additional component (e.g., a synthesizer) into the transceiver may increase cost of production.

Embodiments of the present disclosure provide a wireless communication system that simultaneously receives multiple frequency channels while using a single synthesizer. Embodiments of the radio communication system disclosed herein include a first receiver and a second receiver that share a constant LO frequency generated by the single synthesizer to simultaneously demodulate signals in multiple frequency bands. Embodiments advantageously allow the radio communication system (e.g., a transceiver) to operate in multiple frequency channels without increasing the production cost and without generating unwanted modulation frequencies due to integrating multiple synthesizers on a single substrate.

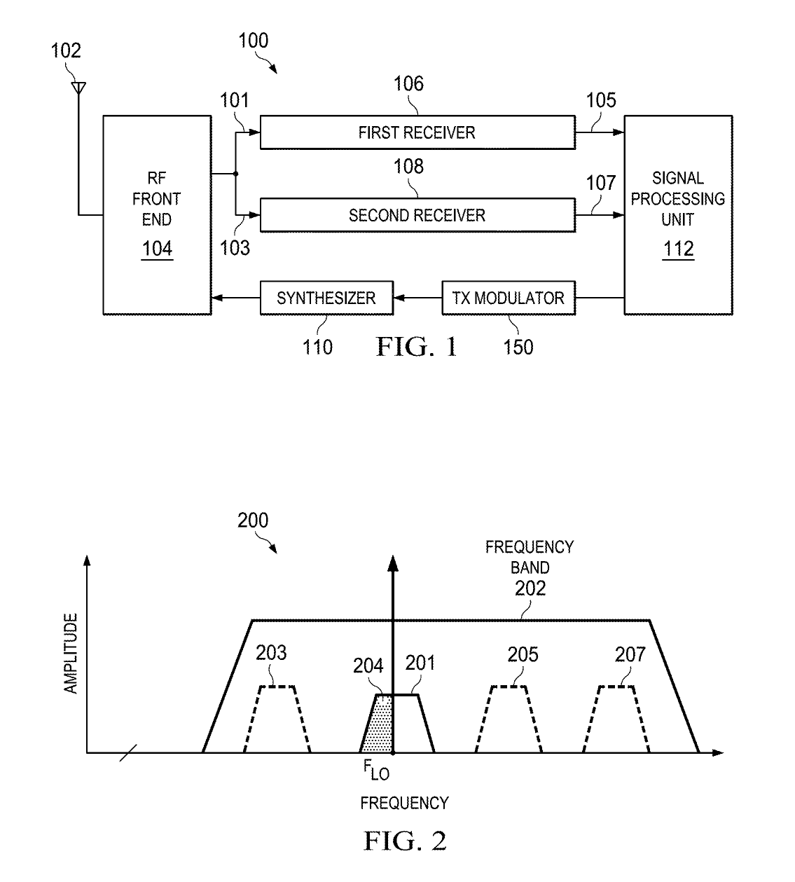

FIG. 1 shows a simplified block diagram of a radio communication system 100 in accordance with various embodiments. The system 100 includes an antenna 102, a radio frequency (RF) front end 104, a first receiver 106, a second receiver 108, a synthesizer 110, a signal processing unit 112 and a transmit (TX) modulator 150. The following description describes several embodiments in which the system 100 is configured to operate as a transceiver in an industrial, scientific and medical (ISM) frequency band and/or a short range device (SRD) frequency band. The system 100 can be applied in any of a variety of applications. For example, the system 100 may be included in a television transceiver, a telephone transceiver, an automotive application, a home automation application, or various other wireless communication devices.

In some embodiments, the system 100 operates as a half-duplex transceiver, which means that the system 100 is configured to provide a non-simultaneously bi-directional communication. At any given time, either a receive (RX) path or a transmit (TX) path is provided. While the RX path is in use, the TX path may be deactivated and vice versa. The RX path and the TX path may use the same RF front end 104 and the antenna 102. As such, the RF front end 104 may include a duplexer configured to switch between the RX path and the TX path. A signal in the RX path starts at the antenna 102, passes through the RF front end 104 and either one of the first receiver 106 and second receiver 108 to the signal processing unit 112. A signal in the TX path may travel through the signal processing unit 112, the TX modulator 150, the synthesizer 110, and the RF front end 104, and be transmitted via the antenna 102. More particularly, in the TX path, the TX modulator 150 is configured to encode digital data, provided by the signal processing unit 112, to a baseband signal and modulate the baseband signal with an RF carrier signal, wherein the RF carrier signal may be provided by the synthesizer 110. Still more particularly, the RF front end 104 may include one or more transmitters which are configured to transmit the modulated RF signal via the antenna 102.

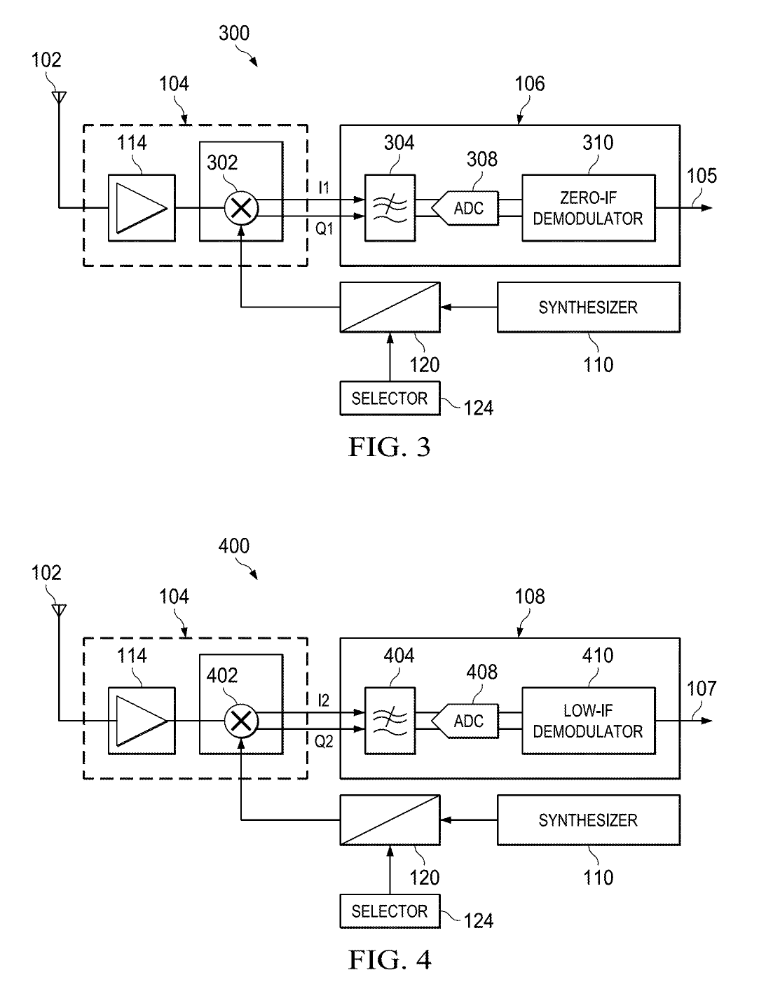

Still referring to FIG. 1, the antenna 102 is configured to receive and/or transmit a RF signal at a radio frequency f_{RF}. Upon receipt of the RF signal over the antenna 102, the RF front end 104 is configured to apply a local oscillation (LO) frequency generated by the synthesizer 110 to downconvert the RF signal to an intermediate frequency (IF) signal. The first receiver 106 coupled to the RF front end 104 is configured to extract information from a signal 101 provided by the RF front end 104 and to generate a signal 105 to be further processed by the signal processing unit 112. Similarly, the second receiver 108 coupled to the RF front end 104 is configured to extract, concurrently with the extraction of information by the first receiver 106 from signal 101, information from a signal 103, and to generate a signal 107 to be further processed by the signal processing unit 112. Details of the extractions in the first receiver 106 and the second receiver 108 will be described with respect to FIG. 3 and FIG. 4.

In order for a conventional transceiver to receive multiple frequency channels simultaneously, either a plurality of synthesizers is needed to generate multiple LO frequencies to downconvert a received RF signal to desired IF channels. The disclosed embodiments utilize a single synthesizer 110 to simultaneously receive multiple channels by implementing a dual-receiver (i.e., the first receiver 106 and the second receiver 108) architecture. In some preferred embodiments, the first receiver 106 may be implemented as a zero-IF receiver and the second receiver 108 may be implemented as a low-IF receiver.

FIG. 2 shows a diagram 200 illustrating amplitude versus frequency of extracted signals (e.g., 105 and 107) in accordance with various embodiments. The diagram 200 includes a predefined frequency band 202, a signal localized at the LO frequency 201, and three additional signals localized at three different frequencies 203, 203 and 207 respectively. In some embodiments, depending on an application and the radio communication system 100 to be implemented, the frequency band 202 may vary. For example, if the system 100 is intended to be used in automotive industry in the United States, the frequency band 202 may be optimally defined from 312 megahertz (MHz) to 315 MHz. If the system 100 is used in Europe, the frequency band 202 may reside between 433.05 MHz to 434.79 MHz. Embodiments are not limited to a particular frequency bands, and any suitable frequency band may be implemented as appropriate for a given application.

In FIG. 2, as described above, the first receiver 106 may be a zero-IF receiver, also known as direct-conversion receiver (DCR), homodyne, synchrodyne receiver. The zero-IF receiver (e.g., 106) is a radio receiver architecture that demodulates an incoming signal (e.g., 101) using a LO frequency provided by a synthesizer (e.g., 110), where the LO frequency is identical or very close to a carrier frequency (i.e., f_{RF}) of a RF signal received by an antenna (e.g., 102). Further, the second receiver 108 may be the low-IF receiver. The low-IF receiver (e.g., 108) is a radio receiver architecture that downconverts a received RF signal to a non-zero low or moderate IF signal, where the IF is typically a few megahertz.

Still referring to FIG. 2, the first receiver 106 demodulates the received RF signal and produces the signal 105 at the LO frequency 201 including a corresponding image signal 204 which may be filtered out by the first receiver 106. The LO frequency 201 is programmable via the synthesizer 110 and/or digital synthesis and processing in the first receiver 106 and second receiver 108. Further, one of the other three signals localized at the frequencies 203, 205, and 207 may be the signal 107 generated by the second receiver 108. The frequency (e.g., 203, 205 and 207) for each of the three signals may be determined by the IF, concurrently with the signal 105 generated by the first receiver 106, using the LO frequency 201. More specifically, the second receiver 108 demodulates the received signal at f_{RF}, using the IF, on the second frequency (e.g., 203, 205 and 207). Since the LO frequency is very close or identical to f_{RF}, the frequencies 203, 205 and 207 may be generalized as: f_{RF}+/−IF. As such, with one LO frequency provided by one synthesizer 110, two frequency bands can be received and processed (demodulated) simultaneously by the system 100. In some embodiments, if there is a third receiver (not shown) coupled to the first receiver 106 and second receiver 108, a third frequency band other than the LO frequency and one of the frequencies (e.g., 203, 205, 207) may also be received and processed simultaneously with the LO frequency and one of the frequencies (e.g., 203, 205, 207).

In some embodiments, the first receiver 106 preferably functions as a monitoring receiver. Thus, the first receiver 106 may continuously receive a signal at an intended frequency (e.g., LO frequency). The intended frequency can be predefined and programmed via the synthesizer 110 as the LO frequency 201. The second receiver 108 may function as a narrowband receiver, which downconverts the received signal at a frequency other than the LO frequency 201 as long as the frequency resides within the frequency band 202. Additionally or alternatively, the LO frequency provided by the synthesizer 110 may not be the intended frequency for the first receiver 106. As such, the first receiver 106 may further downconvert the signal received 101 to the first receiver 106's intended frequency. Concurrently, the second receiver 108 may downconvert the signal 103 to an intended IF.

FIG. 3 shows a simplified diagram 300 of the first receiver 106 coupled to the RF front end 104 and the synthesizer 110 in accordance with various implementations. The first receiver 106 includes a filter 304, an analog-to-digital (ADC) converter 308 and a zero-IF demodulator 310. As shown in FIG. 3, a phase shift unit 120 and a selector 124 are coupled to the synthesizer 110 and the RF front end 104, which further includes a mixer 302 and an amplifier 114. In one embodiment, the filter 304 can be a low-pass filter and the amplifier 114 can be a low-noise amplifier (LNA). In another embodiment, the amplifier 114 can be a variable gain amplifier, and the gain can be selected by one or more control lines (not shown) to the receiver 106. Further, the amplifier 114 can be configured as a single stage amplifier stage or can include multiple amplifier stages. Where multiple amplifier stages are used, the amplifier stages can include serial, parallel, or a combination of serial and parallel amplifier configurations.

In diagram 300, the output of the amplifier 114 is coupled to input of the mixer 302. The mixer 302 is shown as a mixer, but can be any type of frequency conversion device. For example, the mixer 302 can be a harmonic reject mixer, an interferometer, or some other types of frequency conversion device. Further, although the mixer 302 in FIG. 3 is shown as a single mixer, in some embodiments, the mixer 302 may be configured as a pair of mixers, and one of the mixers is configured to generate an in-phase frequency converted signal component I1 and the other is configured to generate a quadrature frequency converted component Q1. As described above, the synthesizer 110 is configured to generate the LO frequency to be used to downconvert, by the RF front end 104, the received RF signal either to the zero-IF signal (i.e., baseband signal) or a signal that can be further downconverted by the zero-IF demodulator 310.

Still referring to diagram 300, the output of the synthesizer 110 is coupled to a phase shift unit 120 that is configured to generate at least two distinct versions of the signal at the LO that are in quadrature. For example, a quadrature LO signal that is a 90 degree phase shifted version of an in-phase LO signal. The in-phase LO signal and the quadrature LO signal are fed into the mixer 302 to generate the in-phase frequency converted signal component I1 and the quadrature frequency converted signal component Q1. Further, the selector 124, coupled to the phase shift unit 120, is configured to selectively provide either of the in-phase LO signal and the quadrature LO signal to the RF front end 104. More particularly, the selector 124 toggles the two distinct versions of the signal at the LO (i.e., the in-phase LO signal and the quadrature LO signal). In another embodiment, the phase shift unit 120 may include a polyphase filter that is configured to generate the two distinct versions of the LO signal.

Based on the LO signal, the mixer 302 may downconvert the RF signal to zero-IF (i.e., baseband). In some preferred embodiments, I1 can be an in-phase zero-IF signal and Q1 can be a quadrature zero-IF signal that both of I1 and Q1 are coupled to the filter 304. Although the filter 304 in 300 is shown as a single filter (e.g., a single low-pass filter), the filter 304 may include multiple stages coupled in serial or in parallel for any suitable applications. For example, the filter 304 may include a first filter path that is configured to function as an in-phase filter and a second filter path, coupled to the first filter path in parallel, configured to function as a quadrature filter. Subsequently, the output of the filter 304 is coupled to the ADC 308, which is configured to receive the downconverted in-phase and quadrature signals and convert them to a digital representation. The digitalized in-phase and quadrature signals are received by the zero-IF demodulator 310 configured to extract information from the digitalized in-phase and quadrature signals on the zero-IF band. As mentioned above, a further downconversion of the signal 101 may be needed. In this regard, the zero-IF demodulator 310 is configured to further downconvert the digitalized in-phase and quadrature signals to the zero-IF band.

FIG. 4 shows a simplified diagram 400 of the second receiver 108 coupled to the RF front end 104 and the synthesizer 110 in accordance with various implementations. In some embodiments, although diagram 400 includes a mixer 402 distinct from the mixer 302 in diagram 300 due to a power consumption consideration, the mixer 402 and the mixer 302 in the RF front end 104 can be implemented as a same mixer. The second receiver 108 is configured similar to that shown and described in the first receiver 106 of diagram 300. The second receiver 108 includes a filter 404, an analog-to-digital (ADC) converter 408 and a low-IF demodulator 410. Again, in some preferred embodiments, the filter 404 may be a single low-pass filter as shown in FIG. 4, or may include multiple stages which include different types of filters (e.g., high-pass filter, band-pass filter) coupled in serial or in parallel as desired. For example, the filter 404 may include two stages of filters coupled in serial where one is a low-pass filter and the other is a high-pass filter.

The second receiver 108 is coupled to the mixer 402 in a fashion similar to that of receiver 106 and mixer 302 described above. The second receiver 108 is configured to receive an in-phase (I2) and a quadrature (Q2) frequency converted signal component from the mixer 402. However, in some embodiments, based on the LO frequency signal, the mixer 402 downconverts the RF signal to a low-IF signal. Thus, I2 can be an in-phase low-IF signal and Q2 can be a quadrature low-IF signal.

Similarly to the first receiver 106 in 300, the filter 404 and the ADC 408 are configured to provide the low-IF demodulator 410 a digital representation of the RF signal at a second frequency (i.e., f_{RF}+/−IF) for extracting information.

Still referring to diagram 400, since the second receiver 108 is preferably configured as the low-IF receiver, including the phase shift unit 120 and the selector 124 to generate and switch the two distinct version of the LO signal may advantageously cover additional frequency bands in addition to the LO frequency, for example, a low-side injection when f_{RF}<LO frequency (e.g., 203) and a high-side injection when f_{RF}>LO frequency (e.g., 205 and 207).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A radio communication system, comprising:
a frequency synthesizer configured to generate an oscillation signal;
a radio frequency (RF) front end configured to receive a detected RF signal and apply the oscillation signal to downconvert the RF signal to an intermediate frequency (IF) signal;
a first receiver coupled to the RF front end and configured to extract, from the IF signal, information wirelessly transmitted by a first RF transmitter on a first frequency channel;
a second receiver coupled to the RF front end and configured to extract, from the IF signal concurrently with the extraction of signal information by the first receiver, information wirelessly transmitted by a second RF transmitter on a second frequency channel.

2. The system of claim 1, wherein the first receiver is a zero-IF receiver and the second receiver is a low-IF receiver.

3. The system of claim 1, wherein the first receiver and the second receiver are configured to programmably vary frequency bands corresponding to the first frequency channel and the second frequency channel.

4. The system of claim 3, wherein the second receiver is configured to programmably vary a width of the second frequency channel.

5. The system of claim 1, comprising:
a phase shift unit configured to generate a quadrature signal that is a 90 degree phase shifted version of the oscillation signal; and
a selector configured to selectably provided either of the oscillation signal and the quadrature signal to the RF front end for use in downconverting the RF signal to the IF signal.

6. The system of claim 1, wherein the first frequency channel and the second frequency channel are channels of an industrial, scientific and medical frequency band or a short range device frequency band.

7. The system of claim 1, the first receiver comprising:
a first bandpass filter, a first analog-to-digital converter (ADC), and a zero IF demodulator; wherein the first ADC is configured to digitize output of the first bandpass filter, and the zero IF demodulator is configured to extract, from digital samples provided by the first ADC, the information wirelessly transmitted by the first RF transmitter on the first frequency channel; and
the second receiver comprising:
a second bandpass filter, a second ADC, and a low IF demodulator;
wherein the second ADC is configured to digitize output of the second bandpass filter, and the low IF demodulator is configured to extract, from digital samples provided by the second ADC, the information wirelessly transmitted by the second RF transmitter on the second frequency channel.

8. An apparatus, comprising:
a frequency synthesizer configured to generate a signal at a local oscillation (LO) frequency;
a radio frequency (RF) front end, comprising a first pair of mixers and a second pair of mixers, configured to downconvert a received RF signal to an intermediate frequency (IF) signal using the LO frequency;
a first receiver coupled to the first pair of mixers and configured to process the IF signal at a first frequency channel; and
a second receiver coupled to the second pair of mixers and configured to process, concurrently with the processed IF signal by the first receiver, the IF signal at a second frequency channel.

9. The apparatus of claim 8, wherein the first receiver is a zero-IF receiver and the second receiver is a low-IF receiver.

10. The apparatus of claim 8, wherein the first pair of mixers is configured to generate an in-phase component and a quadrature component of the IF signal and the second pair of mixers is configured to generate an in-phase component and a quadrature component of the IF signal.

11. The apparatus of 10, further comprising a phase shift switcher, coupled to the RF front end, and configured to shift the LO frequency signal by a 90 degree phase so as to toggle the generated in-phase component and the quadrature component of the IF signal.

12. The apparatus of claim 8, wherein the first sub-receiver and the second-sub receiver are configured to programmably vary frequency bands corresponding to the first frequency channel and the second frequency channel.

13. The apparatus of claim 8, wherein the second-sub receiver is configured to programmably vary a width of the second frequency channel.

14. The apparatus of claim 8, wherein the first frequency channel and the second frequency channel are channels of an industrial, scientific and medical frequency band or a short range device frequency band.

15. The apparatus of claim 8, the first sub-receiver comprising:
a first low-pass filter, a first analog-to-digital converter (ADC), and a zero IF demodulator; wherein the first ADC is configured to digitize output of the first low-pass filter, and the zero IF demodulator is configured to process the digital samples, corresponding to the first frequency channel, provided by the first ADC; and
the second receiver comprising:
a second low-pass filter, a second ADC, and a low IF demodulator; wherein the second ADC is configured to digitize output of the second low-pass filter, and the low IF demodulator is configured to process the digital samples, corresponding to the second frequency channel, provided by the second ADC.

16. A transceiver, comprising:
a common antenna configured to receive and transmit a radio frequency (RF) signal;
a single frequency synthesizer configured to generate a signal at an oscillation frequency;
a radio frequency (RF) front end coupled to the antenna and configured to downconvert the received RF signal to an intermediate frequency (IF) signal based on the generated oscillation frequency,
a transmitter configured to transmit a RF signal over the common antenna;
a first receiver coupled to the RF front end and configured to extract, from the IF signal, information wirelessly transmitted by a first RF transmitter on a first frequency channel; and
a second receiver coupled to the RF front end and configured to extract, from the IF signal, concurrently with the extraction of signal information by the first receiver, information wirelessly transmitted by a second RF transmitter on a second frequency channel.

17. The transceiver of claim 16, wherein the first receiver is a zero-IF receiver and the second receiver is a low-IF receiver.

18. The transceiver of claim 16, wherein the first receiver and the second receiver are configured to programmably vary frequency bands corresponding to the first frequency channel and the second frequency channel.

19. The transceiver of claim 16, comprising:
a phase shift unit configured to generate a quadrature signal that is a 90 degree phase shifted version of the signal at the oscillation frequency; and
a selector configured to selectably provide either of the signal at the oscillation frequency and the quadrature signal to the RF front end for use in downconverting the RF signal to the IF signal.
